(19) United States
(12) Patent Application Publication
(10) Pub. No.: US 2024/0218980 A1
(43) Pub. Date: Jul. 4, 2024

(54) PANEL-INTEGRATED CRYOGENIC TANK COOLING CHANNELS

(71) Applicant: Blue Origin, LLC, Kent, WA (US)

(72) Inventor: Joseph C. Levy, Culver City, CA (US)

(21) Appl. No.: 18/149,589

(22) Filed: Jan. 3, 2023

(51) Int. Cl. F17C 13/00

(52) U.S. Cl. CPC F17C 13/004; F17C 2201/0109; F17C 2203/0646; F17C 2221/017; F17C 2223/0161; F17C 2227/0339; F17C 2265/033

(57) ABSTRACT

A cryogenic tank, or a support structure of a cryogenic tank, is constructed from a number of panels of aluminum extrusion sheets having integrated in-line cooling channels. These channels carry a cooling fluid to absorb heat from the contents of the cryogenic tank, thus cooling the contents. Boil-off vapor from contents of the cryogenic tank or cold helium from another tank may be circulated through the channels to maintain temperatures of the contents in the cryogenic tank, which may be a propellant such as liquid oxygen or liquid hydrogen.

### BACKGROUND

In space, long duration missions generally require a capability to store and maintain propellant throughout the mission. Cryogenic propellants, such as liquid oxygen and liquid hydrogen, are difficult to maintain due to heating in space, which causes these propellants to boil off. Demand continues for a propellant cooling system that has relatively light mass, thermal efficiency, and simple manufacturability, while operating in the confines and limited resources involved in space flight.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a perspective view of the back side of a panel of extruded aluminum sheet with an integrated cooling channel, according to some embodiments.

FIG. 2 is a perspective view of the front side of a panel of extruded aluminum sheet with an integrated cooling channel, according to some embodiments.

FIG. 3 is a cross-section view of a panel of extruded aluminum sheet with an integrated cooling channel, according to some embodiments.

FIG. 4 is a cross-section view of a panel of concave extruded aluminum sheet with an integrated cooling channel, according to some embodiments.

FIG. 5 is a cross-section view of a panel of concave extruded aluminum sheet with an integrated cooling channel that is adjacent to a thin wall of the panel, according to some embodiments.

FIG. 6 is a perspective view of a pair of panels of extruded aluminum sheets, each with an integrated cooling channel, arranged for being welded together, according to some embodiments.

FIG. 7 is a perspective view of a pair of panels of extruded aluminum sheets, each with an integrated cooling channel, welded together, according to some embodiments.

FIG. 8 is a cross-section view of a cryogenic tank comprising panels of extruded aluminum sheet with integrated cooling channels, according to some embodiments.

FIG. 9 is a cross-section view of a skirt support comprising panels of extruded aluminum sheet with integrated cooling channels, the skirt support surrounding a cryogenic tank according to some embodiments.

FIG. 10 is a perspective view of the back side of a panel of extruded aluminum sheet with an integrated cooling channel, the panel including a tapered cut pattern, according to some embodiments.

FIG. 11 is a perspective view of the front side of a panel of extruded aluminum sheet with an integrated cooling channel, the panel including a tapered cut pattern, according to some embodiments.

FIG. 12 is a front view of a cryogenic tank comprising panels of extruded aluminum sheet with integrated cooling channels, the panels having tapered termini for forming end portions of the tank, according to some embodiments.

FIG. 13 is a front view of a cryogenic tank comprising panels of extruded aluminum sheet with integrated cooling channels, the panels terminating at junctions of the end portions of the tank, according to some embodiments.

FIG. 14 is a block diagram of a cryogenic cooling system incorporating a skirt support, according to some embodiments.

FIG. 15 is a block diagram of a cryogenic cooling system incorporating a cooling tank, according to some embodiments.

### DETAILED DESCRIPTION

This disclosure describes architectures and methods of making a cryogenic propellant tank having integrated cooling channels. In addition to earth-orbiting and/or relatively short missions, such a tank may be used for relatively long space flight missions where there is a needed capability to maintain cryogenic propellants (e.g., liquid oxygen and hydrogen) throughout the mission duration. Heating in space, from solar radiation, generally causes cryogenic propellants to boil off, which leads to loss of the propellant to space. For example, even though thermal insulation may be applied to reduce such effects, a cryogenic tank and its contents may absorb thermal radiation, leading to heating of the contents. Another source of heating may be contact points, such as tank support struts or other supporting structure, which conduct heat from the space vessel to the tank.

In embodiments described herein, a cryogenic tank, or a support structure of a cryogenic tank, is constructed from a number of panels of extruded sheets. For example, the panels may be extruded aluminum sheets or extrusions of other materials (e.g., aluminum or aluminum alloy due to their relatively light weight and low cost to manufacture). The extruded sheets may also be made of steel (relatively heavy) or titanium (relatively expensive and may be harder to make). Herein, example embodiments involve aluminum extruded sheets, though claimed subject matter is not so limited.

The aluminum (or other material) extruded sheets have integrated in-line cooling channels. These channels may carry a cooling fluid to absorb heat from the contents of the cryogenic tank, thus cooling the contents (or at least helping to maintain the contents at a particular temperature below vaporization). For example, in one implementation, cold helium may be circulated through the channels to maintain propellant temperatures in the tank.

To fabricate a cryogenic propellent tank with integrated cooling channels, extruded aluminum panels may be welded to one another by friction stir welding (FSW). This method of fabrication may lead to a lightweight propellant cooling system with a relatively highly efficient thermal “attachment” of cooling channels as compared to other methods of combining cooling channels or tubes with a tank, such as the use of adhesives (e.g., epoxies) or mechanical fastening system (e.g., bolts, screws, clamps and associated hardware). This method of fabrication may also be simpler than methods that involve welding channels or tubes to a compound curved surface or welding a compound curved surface of a tube or channel to a straight tank wall.

In some embodiments, spacing between channels, and channel size (e.g., cross-sectional interior area), may be adjusted or varied for individual vehicle applications by adjusting an extrusion die used to fabricate the panels.

Cooling channels that are intrinsically part of the wall of a tank (which comprises a number of the panels of aluminum extrusion sheets having the cooling channels) may approach that of an idealized thermal “attachment”, thus increasing cooling efficiency and reducing cooling mass. The embodiments described herein also eliminate substantial secondary structure mass as compared to methods of channel-to-tank attachments that use brackets, clamps, and fasteners to support the hardware.

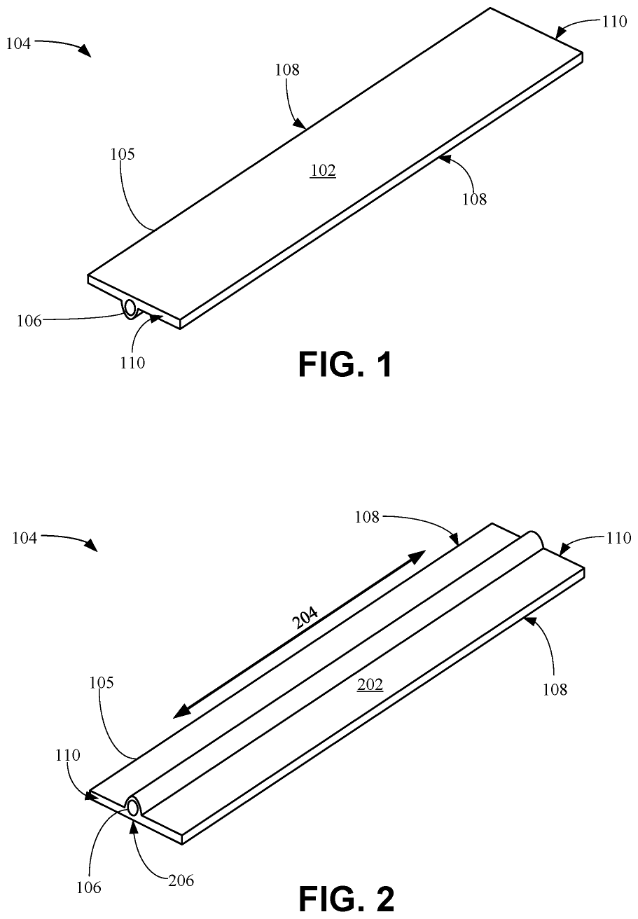

FIG. 1 is a perspective view of a back side 102 of a panel 104 of extruded aluminum sheet 105 with an integrated cooling channel 106, according to some embodiments. Panel 104 includes side edges 108 and end edges 110. Multiple panels 104 may be assembled by a welding process, such as FSW, to form a tank. Adjacent panels 104 may be welded together at side edges 108. Back side 102, upon assembly of multiple panels 104 to form the tank, forms a portion of the interior surface of the tank and is configured to be in contact with a cryogenic fluid. Fundamental parts of panel 104 are sheet 105 and cooling channel 106, both of which are integrally extruded from a single piece of aluminum (e.g., a single common parent material). For example, a single-piece panel 104 may be fabricated using an extrusion-forming process, where a selected material, such as aluminum, is pressed through an extrusion die having a predefined shaped opening matching the selected profile of panel 104. The material emerges from the extrusion die as a single elongated piece with the same profile as the die opening. As noted above, though aluminum is recited in example embodiments herein, and aluminum has a relatively high thermal conductivity, claimed subject matter is not limited to aluminum, and other materials may be extruded or otherwise formed (e.g., via a mold process) in place of aluminum.

FIG. 2 is a perspective view of the front side 202, opposite back side 102, of panel 104 of extruded aluminum sheet 105 with integrated cooling channel 106, according to embodiments. An arrow 204 indicates the lengthwise orientation (e.g., extrusion direction) of panel 104. A thermal-interface portion 206 of sheet 105 is defined as a region of sheet 105 that is substantially between cooling channel 106 and back side 102. Thermal-interface portion 206 is where the cooling fluid in cooling channel 106 has the closest proximity to contents of the tank. In some implementations, thermal-interface portion 206 may be thinner than other portions (e.g., that are away from cooling channel 106) of sheet 105, as described in detail below.

Panel 104 incorporates functional elements of cooling apparatus into a single integrated, unitary piece. For example, because thermal-interface portion 206 of sheet 105 is relatively thin, whether thinner than other portions of sheet 105 or not, cryogenic contents of a tank, which is assembled from panels 104, may be relatively near cooling fluid carried in cooling channels 106. Additionally, the extruded material from which the panels are formed, is preferably highly thermally conductive (e.g., aluminum). These factors contribute to a relatively efficient thermal interaction between cooling channel 106 and the cryogenic contents.

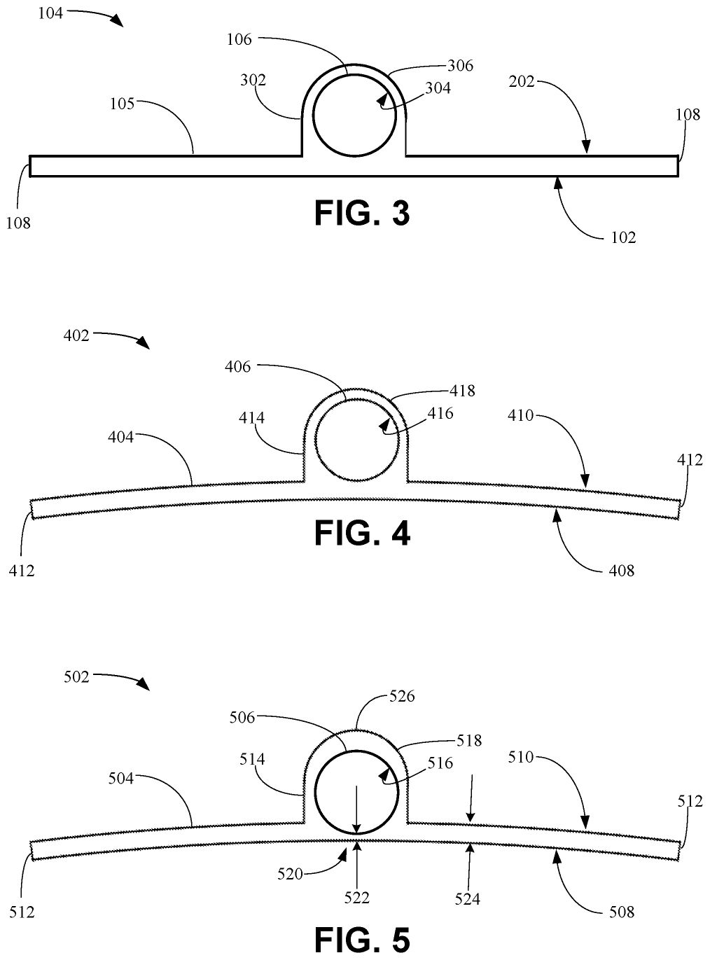

FIG. 3 is a cross-section view of panel 104 of extruded aluminum sheet 105 with integrated cooling channel 106, according to some embodiments. Back side 102, front side 202, and side edges 108 are also visible in this view. A cooling channel wall 302 encloses cooling channel 106. An inside profile 304 and outside profile 306 need not be circular and the thickness therebetween need not be constant along the perimeter. Thickness of wall 302 may be determined in consideration of pressure differential between inside and outside of cooling channel 106 and material strength (e.g., of aluminum), for example.

FIG. 4 is a cross-section view of a panel 402 of an extruded aluminum sheet 404 with an integrated cooling channel 406, according to some embodiments. Panel 402 includes a back side 408, a front side 410, and side edges 412. A cooling channel wall 414 encloses cooling channel 406. An inside profile 416 and outside profile 418 need not be circular and the thickness therebetween need not be constant along the perimeter. Thickness of wall 414 may be determined in consideration of pressure differential between inside and outside cooling channel 406 and material strength (e.g., of aluminum), for example. Panel 402 is similar to panel 104 except that panel 402 is concave on back side 408, whereas back side 102 of panel 104 is substantially linear. Multiple panels 402 may be assembled by a welding process, such as FSW, to form a tank. Adjacent panels 402 may be welded together at side edges 412. Thus, the curvature (e.g., radius of curvature) of back side 408 leads to a particular tank radius. Back side 408, upon assembly of multiple panels 402 to form the tank, forms a portion of the interior surface of the tank and is configured to be in contact with a cryogenic fluid.

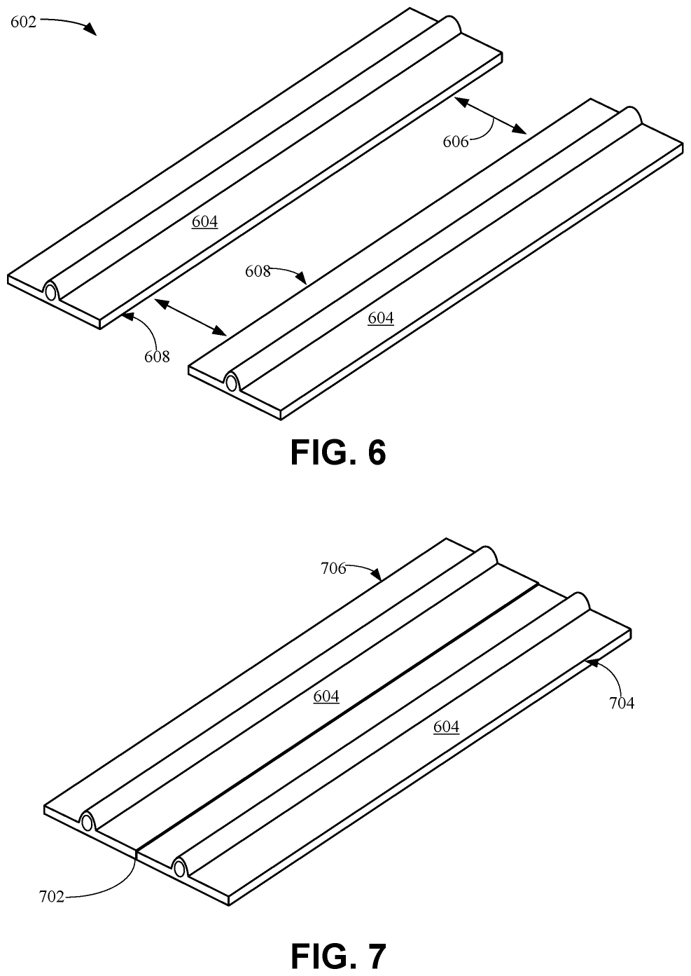

FIG. 5 is a cross-section view of a panel 502 of an extruded aluminum sheet 504 with an integrated cooling channel 506, according to some embodiments. Panel 502 includes a back side 508, a front side 510, and side edges 512. A cooling channel wall 514 encloses cooling channel 506. An inside profile 516 and outside profile 518 need not be circular and the thickness therebetween need not be constant along the perimeter, as shown in the figure. Thickness of wall 514 may be determined in consideration of pressure differential between inside and outside cooling channel 506 and material strength (e.g., of aluminum), for example. Panel 502 is similar to panel 402 except that the cooling channel 506 of panel 502 is positioned closer to back side 508, thus leading to a thin portion 520 of sheet 504 that is substantially thinner than other portions of sheet 504. For example, thin portion 520, being “substantially thinner,” may have a thickness that is at least about 5% less than other portions of sheet 504. This portion is similar to or the same as thermal-interface portion 206 described above. For example, thin portion 520 has a thickness 522 that is substantially less than a thickness 524 of other portions of sheet 504. The extra thinness of thin portion 520 allows for fluid in cooling channel 506 to be relatively close to contents within the tank (that is formed of multiple panels 502), thus increasing thermal conductive efficiency for cooling the contents by the cooling fluid flowing in the cooling channel. Detrimentally, the extra thinness may also compromise the strength of the tank, because thin portions 520 may form relatively weak lines longitudinally around the perimeter of the tank. However, cooling channel wall 514, which may be made relatively thick at a top portion 526, may more than compensate for the weakness caused by thin portion 520. In particular, pressure by contents of the tank is exerted outward against back side 508. This pressure leads to a tendency for thin portion 520 to bend outward. This tendency, however, will place cooling channel wall 514 in tension and thin portion 520 in compression. The tension and compression combination will resist and prevent such bending. Accordingly, the configuration of thin portion 520, cooling channel 506 and cooling channel wall 514 may function together to maintain strength and overall integrity of the tank wall.

FIG. 6 is a perspective view of a process 602 of adjoining a pair of panels 604 of extruded aluminum sheets with integrated cooling channels, according to some embodiments. Panels 604 are arranged for being welded together by FSW, for example. Arrow 606 indicates the relative direction of two panels as they are brought into contact with each other for the welding process. Side edges 608 of the respective panels are welded together.

FIG. 7 is a perspective view of the pair of panels 604 welded together at a weld line 702 (which comprises former side edges 608), according to some embodiments. Subsequent panels (not shown) may be adjoined to the pair at edges 704 and 706, respectively. Such adjoining may be performed to construct a tank. In some implementations of constructing a substantially cylindrical tank, panels 604 may be welded together at an angle so that a group of panels adjoined at such an angle form a closed cylinder of the tank (e.g., the tank being not a true cylinder, but faceted in a cylindrical manner). In some alternative implementations of constructing a substantially cylindrical tank, concave panels 402 or 502 may be welded together so that a group of the panels form a closed cylinder of the tank (e.g., the tank having a radius determined by the concavity (radius of curvature) of the panels).

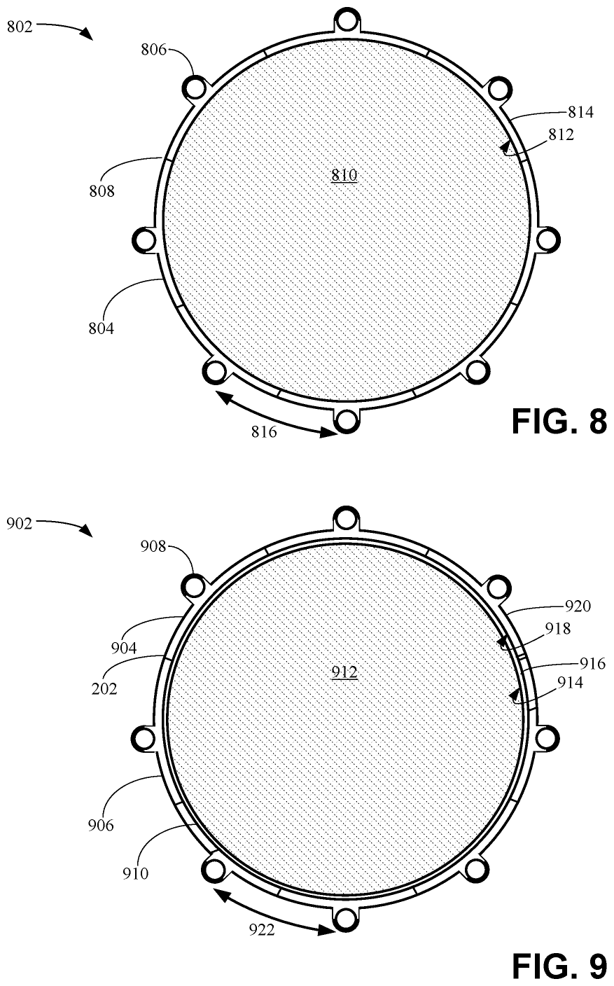

FIG. 8 is a cross-section view of a cryogenic tank 802 comprising individual panels 804 of extruded aluminum sheet with integrated cooling channels 806, according to some embodiments. Panels 804 may be the same as or similar to panels 502 of FIG. 5. Panels 804 may be joined to one another at joints 808 by welding, such as FSW. Tank 802 is configured to contain a fluid 810, such as a cryogenic fluid (e.g., liquid oxygen or liquid hydrogen).

In a particular example embodiment, cryogenic tank 802 may comprise a portion of a cryogenic cooling system that includes the tank, which has an inside surface 812 and an outside surface 814. Inside surface 812 is configured to contain cryogenic fluid 810. As illustrated, cooling channels 806, integrated into individual panels 804 that are welded together to form tank 802, are on the outside surface 814 of the tank. The cooling channels are oriented along the largest dimension of each of the panels and are configured to receive and carry a cooling fluid (not shown). In some embodiments, described below, the cooling fluid comprises a gas that is boil-off vapor of fluid 810. In other embodiments, described below, the cryogenic cooling system may include a cryogenic helium tank connected to cooling channels 806. Accordingly, the cooling fluid is helium.

In some implementations, at a given circular cross-section of the tank, as illustrated in FIG. 8, for example, a circumferential distance between adjacent cooling channels 806 of respective adjacent panels 804 may vary around the circumference of tank 802 to accommodate different cooling rates at different parts of the tank. In other words, a circumferential distance 816 between adjacent cooling channels may be different for different pairs of panels 804.

FIG. 9 is a cross-section view of a tank and skirt support configuration 902, according to some embodiments. A skirt support 904 comprises panels 906 of extruded aluminum sheet with integrated cooling channels 908. Skirt support 904 surrounds a cryogenic tank 910 configured to contain a cryogenic fluid 912. Skirt support 904 is configured to physically support cryogenic tank 910. Configuration 902 may be a portion of a cryogenic cooling system that includes tank 910 having an inside surface 914 and an outside surface 916, the inside surface configured to contain cryogenic fluid 912. Skirt support 904 concentrically surrounds at least a portion of tank 910 and is in thermal contact with the tank. Skirt support 904 has an inside surface 918 and an outside surface 920. Inside surface 918 of skirt support 904 faces outside surface 916 of tank 910.

As illustrated, cooling channels 908, integrated into individual panels 906 that are welded together to form skirt support 904, are on outside surface 920 of the skirt support. The cooling channels are oriented along the largest dimension of each of the panels and are configured to receive and carry a cooling fluid (not shown). In some embodiments, described below, the cooling fluid comprises a gas that is boil-off vapor of fluid 912. In other embodiments, described below, the cryogenic cooling system may include a cryogenic helium tank connected to cooling channels 908. Accordingly, the cooling fluid is helium.

In some implementations, at a given circular cross-section of tank 910, as illustrated in FIG. 9, for example, a circumferential distance between adjacent cooling channels 908 of respective adjacent panels 906 may vary around the circumference of skirt support 904 (and similarly for tank 910) to accommodate different cooling rates at different parts of the tank. In other words, a circumferential distance 922 between adjacent cooling channels may be different for different pairs of panels 906.

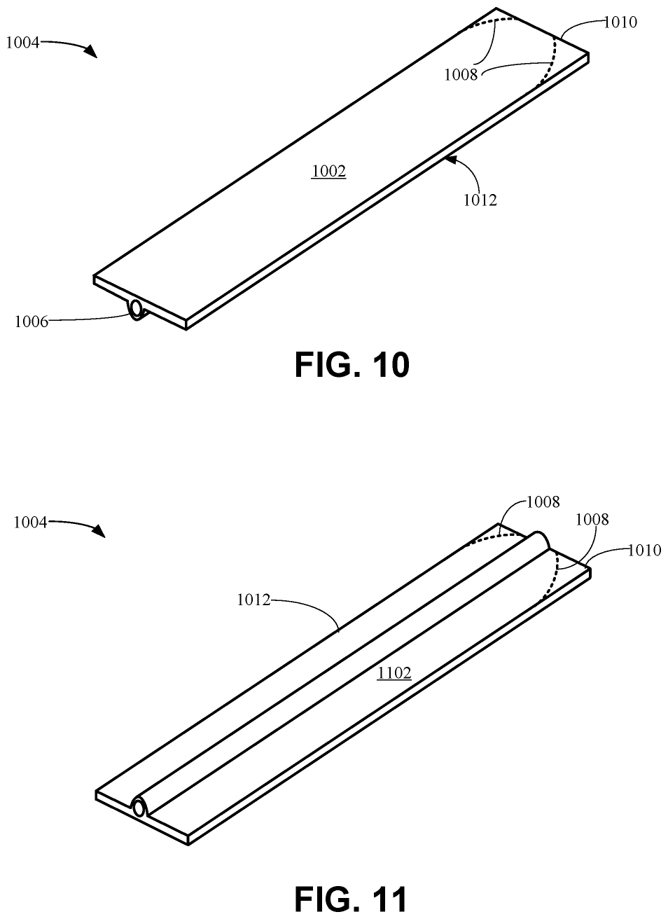

FIG. 10 is a perspective view of the back side 1002 of a panel 1004 of extruded aluminum sheet with an integrated cooling channel 1006, the panel including a tapered cut pattern 1008, according to some embodiments. FIG. 11 is a perspective view of the front side 1102 of panel 1004. Other than inclusion of pattern 1008, panel 1004 is the same as or similar to panel 104 of FIG. 1. A terminus 1010 of panel 1004 may be cut or otherwise formed according to pattern 1008 so that a group of such panels, welded together at side edges 1012, to form a tank, may geometrically fit together at a conical or semispherical end of the tank (e.g., the bottom and/or top of the tank). More details about this are explained below. For example, pattern 1008 may be linear so that the group of panels forms a cone. In another example, pattern 1008 may be curved, as illustrated in FIGS. 10 and 11, so that the group of panels forms a semi-sphere.

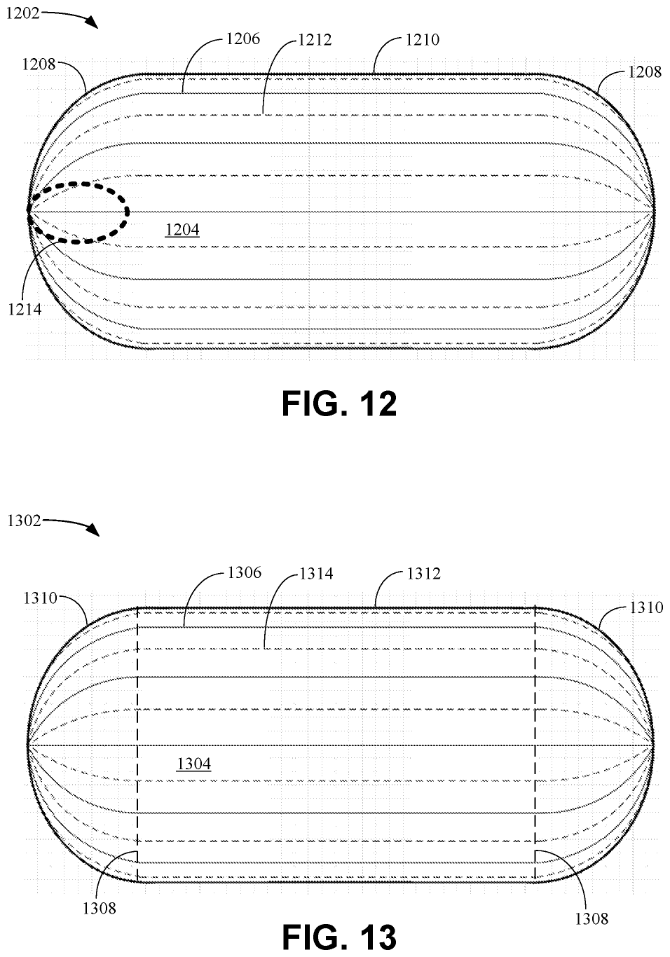

FIG. 12 is a front view of a cryogenic tank 1202 comprising panels 1204 of extruded aluminum sheet with integrated cooling channels 1206, the panels having tapered termini for forming end portions 1208 of the tank, according to some embodiments. Tank 1202 includes a cylindrical portion 1210 between end portions 1208. Individual panels 1204 are joined at welded seams 1212. A tapered portion of an individual panel 1204 is indicated by dashed ellipse 1214. Such a tapered portion may correspond to a tapered cut pattern 1008, described above for FIG. 10, for example. In other implementations, end portions 1208 may be conical instead semispherical, as illustrated. In the former case, as explained above, tapered cut pattern 1008 may be linear instead of curved.

FIG. 13 is a front view of a cryogenic tank 1302 comprising panels 1304 of extruded aluminum sheet with integrated cooling channels 1306, the panels terminating at the junctions 1308 of the end portions 1310 of the tank, according to some embodiments. Tank 1302 includes a cylindrical portion 1312 between end portions 1310 and terminating at junctions 1308. Individual panels 1304 are joined at welded seams 1314. In contrast to tank 1202, individual panels 1304 do not include a tapered portion. Instead, panels 1304 terminate at 1308, such as at end edges 110, illustrated in FIG. 1, for example. In some implementations, end portions 1310 are fabricated separately from portion 1312. Such fabrication may be performed by any of a number of methods and materials, the end result being one that accommodates the adjoined end edges 110 of panels 1304 that form cylindrical portion 1312. For example, end caps of a cylindrical section may be made from a relatively traditional spun dome with cooling channels bonded thereto.

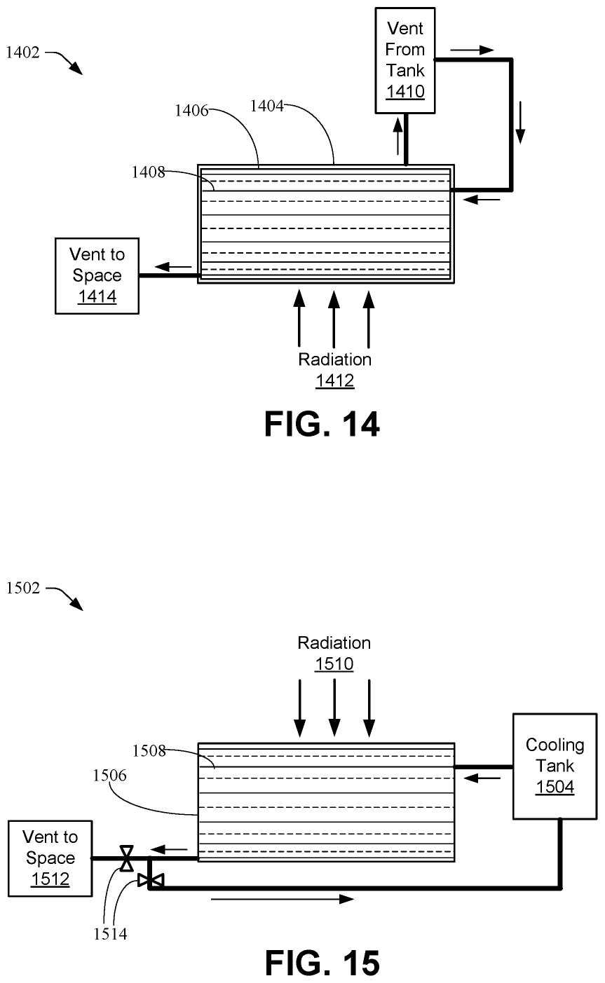

FIG. 14 is a block diagram of a cryogenic cooling system 1402 incorporating a skirt support 1404 at least partially surrounding a cryogenic tank 1406, according to some embodiments. The combination of skirt support 1404 and cryogenic tank 1406 may be the same as or similar to tank and skirt support configuration 902, described above. Skirt support 1404 includes cooling channels 1408. A vent port 1410 allows boil-off vapor of cryogenic contents of tank 1406 to be routed into structural elements, such as skirt support 1404, via cooling channels 1408. Heat generated by radiation (e.g., solar radiation) 1412 enters tank 1406 and partially vaporizes the cryogenic contents of the tank. The vapor (e.g., boil-off vapor), though in a boiled-off vapor state, remains relatively cold. This vapor is useful as a coolant for the cryogenic contents of tank 1406 and is thus routed into cooling channels 1408 to cool the cryogenic contents. After routed by the cooling channels, the vapor may be vented into space at a vent 1414. Other implementations of a cryogenic cooling system may be the same as 1402 but without a skirt support that includes cooling channels (e.g., such as 904). In such implementations, cooling channels may be incorporated into the tank, as illustrated in FIG. 8, for example.

FIG. 15 is a block diagram of a cryogenic cooling system 1502 incorporating a cooling tank 1504, according to some embodiments. System 1502 also includes a main cryogenic tank 1506 that incorporates cooling channels 1508, such as 802 described above, for example. Heat generated by radiation (e.g., solar radiation) 1510 enters tank 1506, heating the cryogenic contents of the tank. To maintain the temperature of propellant or other cryogenic contents stored in tank 1506, system 1502 may allow for circulating cold helium from cooling tank 1504 through cooling channels 1508 incorporated into the tank walls. At the end of such circulation, the helium may be vented into space via vent 1512 or recirculated back into cooling tank 1504, depending on positions of flow valves 1514. In other implementations, the helium may be recirculated to a cryocooler to remove the heat picked up in the cooling channels before being further recirculated into the cooling tank. Still other implementations of a cryogenic cooling system may be the same as 1502 but with a skirt support that includes cooling channels (e.g., such as 904). In such implementations, cooling channels may be incorporated into the skirt support instead of the tank, as illustrated in FIG. 9, for example.

All of the methods and processes described above may be embodied in, and fully automated via, software code modules executed by one or more general purpose computers or processors. The code modules may be stored in any type of computer-readable medium, computer storage medium, or other computer storage device. Some or all of the methods may alternatively be embodied in specialized computer hardware.

Conditional language such as, among others, “can,” “could,” “may” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A cryogenic cooling system comprising:
a tank having an inside surface and an outside surface, the inside surface configured to contain a cryogenic fluid; and
at least one cooling channel integrated into individual panels that are welded together to form the tank, wherein
the at least one cooling channel is on the outside surface of the tank,
the at least one cooling channel is oriented along the largest dimension of each of the panels,
the at least one cooling channel is configured to receive and carry a cooling fluid, and each of the panels is made of an extruded aluminum sheet that integrates the at least one cooling channel.

2. The cryogenic cooling system of claim 1, wherein the cooling fluid comprises a gas that is boil-off vapor of the cryogenic fluid in the tank.

3. The cryogenic cooling system of claim 1, further comprising a cryogenic helium tank connected to the at least one cooling channel, wherein the cooling fluid comprises helium.

4. The cryogenic cooling system of claim 1, wherein each of the panels has a cross-section having a concave surface that comprises a portion of the inside surface of the tank.

5. The cryogenic cooling system of claim 1, wherein at least some of the panels are welded to one another by friction stir welding (FSW) to form a group of panels that form at least a portion of the tank.

6. The cryogenic cooling system of claim 5, wherein a terminus of the largest dimension of each of the panels is tapered so that the group of panels accommodate a conic or spherical shape of a portion of the tank.

7. The cryogenic cooling system of claim 1, wherein, at a given circular cross-section of the tank, a circumferential distance between adjacent cooling channels of respective adjacent panels varies around the circumference of the tank to accommodate different cooling rates at different parts of the tank.

8. The cryogenic cooling system of claim 1, wherein each of the panels comprises the at least one cooling channel and a sheet having a back side being a portion of the inside surface of the tank, wherein a portion of the sheet between the at least one cooling channel and the back side is substantially thinner than other portions of the sheet.

9. A cryogenic cooling system comprising:
a tank having an inside surface and an outside surface, the inside surface configured to contain a cryogenic fluid;
a skirt support concentrically surrounding at least a portion of the tank and in thermal contact with the tank, wherein the skirt support has an inside surface and an outside surface, the inside surface of the skirt support facing the outside surface of the tank; and
a cooling channel integrated into individual panels that are welded together to form the skirt support, wherein
the cooling channel is on the outside surface of the skirt support,
the cooling channel is oriented along the largest dimension of the panels,
the cooling channel is configured to receive and carry a cooling fluid, and
each of the panels is made of an extruded aluminum sheet that integrates the cooling channels.

10. The cryogenic cooling system of claim 9, wherein the cooling fluid comprises a gas that is boil-off vapor of the cryogenic fluid in the tank.

11. The cryogenic cooling system of claim 9, further comprising a cryogenic helium tank, wherein the cooling fluid comprises helium.

12. The cryogenic cooling system of claim 9, wherein each of the panels has a cross-section having a concave surface that comprises a portion of the inside surface of the skirt support.

13. The cryogenic cooling system of claim 9, wherein at least some of the panels are welded to one another by friction stir welding (FSW) to form a group of panels that form at least a portion of the skirt support.

14. The cryogenic cooling system of claim 9, wherein, at a given circular cross-section of the tank, a circumferential distance between adjacent cooling channels of respective adjacent panels varies around the circumference of the tank to accommodate different cooling rates at different parts of the skirt support.

15. A method for cryogenic cooling, the method comprising:
circulating a cooling fluid through cooling channels that are integrated with a cryogenic tank by an extrusion process, wherein
the cryogenic tank comprises panels formed by the extrusion process, which integrates each of the cooling channels as part of the panels,
the panels are adjoined to one another by friction surface welding (FSW), and
the cooling channels are located outside of the cryogenic tank.

16. The method of claim 15, further comprising:
collecting a gas that is boil-off vapor of cryogenic fluid in the cryogenic tank; and
directing the gas into the cooling channels, wherein the cooling fluid comprises the gas.

17. The method of claim 15, further comprising:
directing helium into the cooling channels from a cryogenic helium tank connected to the cooling channels, wherein the cooling fluid comprises the helium.

18. The method of claim 15, wherein each of the panels is made of an extruded aluminum sheet that integrates one of the cooling channels.

19. The method of claim 15, wherein each of the panels has a cross-section having a concave surface that comprises a portion of an inside surface of the cryogenic tank.

20. The method of claim 15, wherein, at a given circular cross-section of the cryogenic tank, a circumferential distance between adjacent cooling channels of respective adjacent panels varies around the circumference of the tank to accommodate different cooling rates at different parts of the tank.
